(19) United States
(12) Patent Application Publication
(10) Pub. No.: US 2024/0187136 A1
(43) Pub. Date: Jun. 6, 2024

(54) BASE STATION, TERMINAL, AND COMMUNICATION METHOD

(71) Applicant: Panasonic Intellectual Property Corporation of America, Torrance, CA (US)

(72) Inventors: Akihiko NISHIO, Osaka (JP); Ayako HORIUCHI, Kanagawa (JP)

(21) Appl. No.: 18/553,709

(22) PCT Filed: Dec. 21, 2021
(86) PCT No.: PCT/JP2021/047271

§ 371 Date: Oct. 2, 2023

(30) Foreign Application Priority Data
Apr. 6, 2021 (JP) 2021-064668

(51) Int. Cl. H04L 1/08

(52) U.S. Cl. CPC H04L 1/08

(57) ABSTRACT

This base station is provided with: a control circuit which determines information to be set in a signal for notifying a number of data allocations in a retransmission process, on the basis of a setting relating to feedback for the retransmission process; and a transmission circuit for transmitting the information in the signal.

### TECHNICAL FIELD

The present disclosure relates to a base station, a terminal, and a communication method.

### BACKGROUND ART

In the standardization of 5G, New Radio access technology (NR) was discussed in 3GPP, and specification of Release 15 (Rel. 15) of NR was published.

### CITATION LIST

### Non Patent Literature

NPL 1
3GPP, TR 38.821, V16.0.0 “Solutions for NR to support non-terrestrial networks (NTN) (Release 16)”, 2019-12
NPL 2
3GPP, TS 38.213, V16.5.0 “NR; Physical layer procedures for control (Release 16)”, 2021-03
NPL 3
3GPP, TS 38.214, V16.5.0 “NR; Physical layer procedures for data (Release 16)”, 2021-03

### SUMMARY OF INVENTION

There is scope for further study, however, on a method for improving retransmission control efficiency.

One non-limiting and exemplary embodiment facilitates providing abase station, a terminal, and a communication method each capable of improving retransmission control efficiency.

A base station according to an embodiment of the present disclosure includes: control circuitry, which, in operation, determines information to be configured to a signal based on a configuration related to feedback for a retransmission process, the signal indicating a number of assignments of data in the retransmission process; and transmission circuitry, which, in operation, transmits the information in the signal.

It should be noted that general or specific embodiments may be implemented as a system, an apparatus, a method, an integrated circuit, a computer program, a storage medium, or any selective combination thereof.

According to an exemplary embodiment of the present disclosure, it is possible to improve retransmission control efficiency.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates exemplary downlink assignment index (DAI) and hybrid automatic repeat request-acknowledgement (HARQ-ACK) codebook;

FIG. 2 is a block diagram illustrating an exemplary configuration of a part of a base station:

FIG. 3 is a block diagram illustrating an exemplary configuration of a part of a terminal;

FIG. 4 is a block diagram illustrating an exemplary configuration of the base station;

FIG. 5 is a block diagram illustrating an exemplary configuration of the terminal;

FIG. 6 is a sequence diagram describing exemplary operations of the base station and the terminal;

FIG. 7 illustrates exemplary DAI and HARQ-ACK codebook according to Configuration Method 1:

FIG. 8 illustrates exemplary DAI and HARQ-ACK codebook according to Configuration Method 2;

FIG. 9 illustrates exemplary DAI and HARQ-ACK codebook according to Configuration Method 3:

FIG. 10 illustrates exemplary DAI and HARQ-ACK codebook according to Configuration Method 4:

FIG. 11A illustrates an exemplary case with blind retransmission:

FIG. 11B illustrates an exemplary case without blind retransmission;

FIG. 12 illustrates an exemplary configuration of an extended new data indicator (NDI);

FIG. 13A illustrates an exemplary configuration of a retransmission indication bit in a DAI field in a case with blind retransmission;

FIG. 13B illustrates an exemplary configuration of the retransmission indication bit in the DAI field in a case without blind retransmission;

FIG. 14 illustrates an exemplary architecture of a 3GPP NR system;

FIG. 15 is a schematic diagram illustrating a functional split between NG-RAN and 5GC:

FIG. 16 is a sequence diagram of an RRC connection setup/reconfiguration procedure:

FIG. 17 schematically illustrates usage scenarios of enhanced Mobile BroadBand (eMBB), massive Machine Type Communications (mMTC), and Ultra Reliable and Low Latency Communications (URLLC); and

FIG. 18 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

### [About Retransmission Control]

In long term evolution (LTE) or 5G NR, a hybrid automatic repeat request (HARQ) is applied to retransmission control during data transmission, for example.

In HARQ, a transmission side, for example, performs channel coding (forward error correction (FEC)), such as turbo-coding or low density parity check (LDPC) coding, on data and then transmits the data. During data decoding, a reception side, for example, saves (i.e., also referred to as buffers, stores, or holds) received data (e.g., soft determination value) in a buffer when the received data includes an error. Note that a buffer is also referred to as, for example, a HARQ soft buffer or simply a soft buffer. During retransmission of data, for example, the reception side combines (soft combines) the received data (e.g., retransmission data or data relating to retransmission request) and the previously received data (i.e., saved data), and decodes the combined data.

This allows the reception side to decode data using data with improved received quality (e.g., signal to noise ratio (SNR)) in HARQ. Meanwhile, in HARQ, the transmission side can improve coding gain by transmitting a parity bit different from that in the previous transmission (e.g., different redundancy version (RV)). Further, in HARQ, continuous data transmission is possible by using a plurality of processes (also called as HARQ processes or retransmission processes, for example) taking into account a propagation path delay or processing delays on the transmission side and the reception side. In this case, the reception side separates the received data by process ID (sometimes expressed as “PID” or “HARQ process ID”), which is identification information for identifying the process (or data), and saves the data in the buffer.

In LTE or NR, for example, a base station (also referred to as eNB or gNB, for example) indicates information on HARQ, such as a process ID, new data indicator (NDI), and RV, to a terminal (also referred to as user equipment (UE), for example) when assigning data. The terminal performs reception processing (e.g., software combining processing) on the data (e.g., physical downlink shared channel (PDSCH)) based on the information on HARQ indicated from the base station.

In addition, the terminal, for example, transmits (or feeds back) a response signal (hereinafter referred to as “HARQ-Acknowledgement (HARQ-ACK)” or HARQ information) indicating the presence or absence of an error in the received data to the base station. HARQ-ACK may be transmitted using, for example, an uplink control channel (e.g., physical uplink control channel (PUCCH)) or an uplink data channel (e.g., physical uplink shared channel (PUSCH)).

The base station may, for example, specify a slot in which the terminal transmits HARQ-ACK in downlink control information (DCI) that assigns PDSCHs.

Here, for example, in a case of time division duplex (TDD) system, uplink slots are configured (i.e., limited) to a part of time resources, and thus HARQ-ACKs for a plurality of respective PDSCHs are sometimes collectively transmitted in the same uplink slot. In a frequency division duplex (FDD) system or the TDD system, for example, in a case of carrier aggregation (CA). HARQ-ACKs for a plurality of respective PDSCHs transmitted in a plurality of component carriers (CCs) or cells are sometimes collectively transmitted in a single CC of a single slot.

In such cases, the terminal may transmit, for example, a bit string of HARQ-ACK bits including a plurality of HARQ-ACKs (hereinafter referred to as a “HARQ-ACK codebook”) in a PUCCH or PUSCH. The number of HARQ-ACK bits transmitted in a certain slot may vary depending on the number of PDSCH assignments, for example.

NR Rel. 15 or Rel. 16 (hereinafter sometimes referred to as NR Rel. 15/16) specifies, for example, a “Type 1 HARQ-ACK codebook”, the size of HARQ-ACK codebook is semi-statically determined, and a “Type 2 HARQ-ACK codebook”, the size of HARQ-ACK codebook is dynamically determined (see, for example, section 9 of NPL 2).

In the Type 1 HARQ-ACK codebook, for example, by including a bit indicating negative acknowledgement (NACK) in a HARQ-ACK bit for a slot or CC with no PDSCH assignment, the size of HARQ-ACK codebook is configured to be constant regardless of PDSCH assignment.

Meanwhile, in the Type 2 HARQ-ACK codebook, for example, HARQ-ACK bits for slots or CCs with PDSCH assignment are included in the HARQ-ACK codebook. In other words, in the Type 2 HARQ-ACK codebook, for example, a HARQ-ACK bit for a slot or CC with no PDSCH assignment is not included in the HARQ-ACK codebook. For example, the terminal determines the presence or absence of a HARQ-ACK bit for a PDSCH received in each slot and each CC based on whether DCI including information on PDSCH assignment is received in the slot or CC. Here, when the terminal fails to receive DCI (e.g., decoding error or error detection), for example, the terminal may make a mistake in determining the presence or absence of the HARQ-ACK bit, possibly causing disagreement in perception regarding HARQ (e.g., HARQ-ACK codebook size) between the base station and the terminal.

One way to align the perceptions between the base station and the terminal regarding HARQ is introduction of a downlink assignment index (DAI) indicated to the terminal by DCI assigning PDSCHs, for example. For example, DAI may indicate information on the number of PDSCH assignments to the terminal. The indication of DAI allows the terminal to specify the correct size of a HARQ-ACK codebook even though the terminal fails to receive DCI, for example. Note that the term “specify” may be replaced by another term such as “discriminate”, “identify”, “recognize”, “determine”, and “estimate”.

For example, DAI includes “Counter-DAI (C-DAI)”, which counts slots and CCs with PDSCH assignment until the slot and CC where the DAI is indicated, and “Total-DAI (T-DAI)”, which indicates the total number of PDSCH assignments until the slot.

In other words, C-DAI may indicate, for example, the cumulative number of pairs of slots and CCs (or pairs of serving cells and PDCCH monitoring occasions) with PDSCH reception (or PDSCH assignment) until the present CC and slot (or serving cell and PDCCH monitoring occasion). Meanwhile. T-DAI may indicate, for example, the total number of pairs of slots and CCs (or pairs of serving cells and PDCCH monitoring occasions) with PDSCH reception (or PDSCH assignment) until the present slot (or PDCCH monitoring occasion).

For example, C-DAI may be incremented at each PDSCH assignment in DCI in each slot and CC. For example, T-DAI may indicate the total number of PDSCH assignments until the slot (including the slot) where the DAI is indicated. Each of C-DAI and T-DAI may be represented by, for example, two bits. Note that C-DAI and T-DAI may be able to count four or more even though they are represented by two bits.

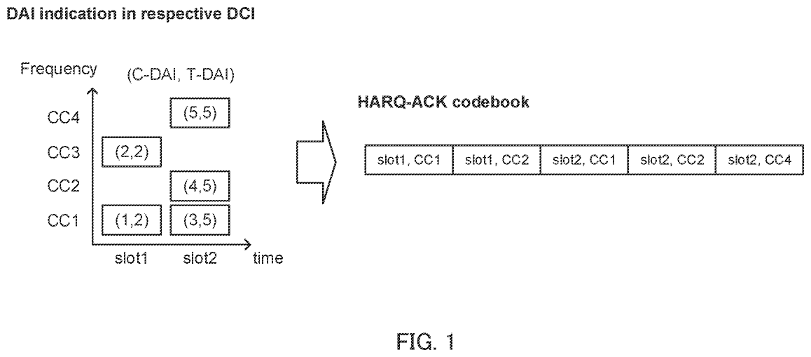

FIG. 1 illustrates exemplary DAIs (e.g., C-DAI and T-DAI) included in DCI assigning PDSCH and an exemplary HARQ-ACK codebook transmitted by the terminal.

In FIG. 1, the terminal may receive DCI including DAI (C-DAI, T-DAI) in any of slots (slot1 and slot2 in FIG. 1) and CCs (CC1 to CC4 in FIG. 1), for example. In the example illustrated in FIG. 1, for the terminal, PDSCHs are assigned in CC1 and CC3 of slot1, and PDSCHs are assigned in CC1, CC2, and CC4 of slot2. In this case, the terminal may receive, in the slots and CCs with PDSCH assignment, DAI including C-DAI indicating a count value of the number of PDSCH assignments and T-DAI indicating the total number of PDSCH assignments until the slot.

By way of example, a description will be given of a case where the terminal fails to receive DCI in CC1 of slot2 in FIG. 1. In this case, the terminal can identify that reception failure of DCI has occurred in CC1 of slot2 based on, for example, DAI (4, 5) received in CC2 of slot2. This allows terminal 200 to feed back a HARQ-ACK codebook including HARQ-ACK bits for the five PDSCHs assigned by base station 100 as illustrated in FIG. 1, for example. In this manner, DAI can prevent terminal 200 from misidentifying the size of the HARQ-ACK codebook.

### [Extension to Non-Terrestrial Network (NTN)]

LTE and NR Rel. 15/16 have been specified as a radio access technology for terrestrial networks. Meanwhile, an extension of NR to a non-terrestrial network (NTN) such as communication using a satellite and/or a high-altitude platform station (HAPS) has been studied (e.g., NPL 1).

In the NTN environment, a coverage area (e.g., one or more cells) of a satellite for a terminal on the ground or a terminal located in airspace, such as an aircraft or drone, is formed by a beam from the satellite. In addition, a round trip time (RTT) of radio wave propagation between the terminal and the satellite is determined depending on the altitude of the satellite (e.g., approximately up to 36000 km) and the angle viewed from the terminal, that is, the positional relation between the satellite and the terminal.

For example, NPL 1 describes that the round trip time (RTT) of radio wave propagation between the base station and the terminal takes up to approximately 540 ms in the NTN.

For example, retransmission control is performed based on individual HARQ-ACK feedback to a HARQ process. Thus, in the NTN where the RTT is long compared to a terrestrial network, a large number of HARQ processes is possibly used for consecutive data transmissions. Further, for example, in the NTN, disabling HARQ-ACK feedback for the HARQ process individually is considered (see, for example, NPL 1).

For example, in a HARQ process for which feedback is enabled (e.g., feedback-enabled HARQ process), a terminal may transmit HARQ-ACK and a base station may perform scheduling based on the HARQ-ACK. Meanwhile, for example, in a HARQ process for which feedback is disabled (e.g., feedback-disabled HARQ process), a terminal transmits no HARQ-ACK and a base station may schedule the next data without waiting for reception of HARQ-ACK.

Here, in the above-described Type2 HARQ-ACK codebook (i.e., dynamic codebook), it may be assumed that the HARQ-ACK codebook does not include a HARQ-ACK bit for a PDSCH of the feedback-disabled HARQ process. In this case, a content of information indicated (or instructed) in a DAI field included in DCI for scheduling (e.g., assigning) the feedback-disabled HARQ process has not been fully studied.

A non-limiting embodiment of the present disclosure describes methods for improving HARQ processing efficiency using, for example, DAI (e.g., C-DAI and T-DAI) for the feedback-disabled HARQ process. For example, information configured to DAI (e.g., C-DAI and T-DAI) may be determined (or controlled) based on a configuration (e.g., enabled or disabled) related to HARQ feedback.

### [Overview of Communication System]

A communication system according to an embodiment of the present disclosure includes base station 100 and terminal 200.

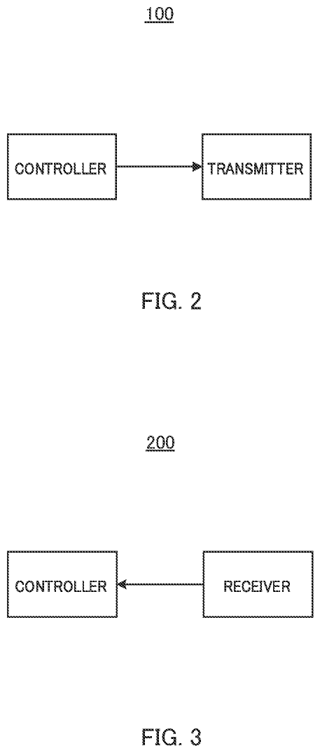

FIG. 2 is a block diagram illustrating an exemplary configuration of a part of base station 100. In base station 100 illustrated in FIG. 2, a controller (e.g., corresponding to control circuitry) determines information to be configured to a signal (e.g., DAI) indicating the number of data assignments in a retransmission process (e.g., HARQ process) based on a configuration related to feedback (e.g., whether enabled or disabled) for the retransmission process. A transmitter (e.g., corresponding to transmission circuitry) transmits, for example, determined information in the signal (e.g., DAI).

FIG. 3 is a block diagram illustrating an exemplary configuration of a part of terminal 200. In terminal 200 illustrated in FIG. 3, a receiver (e.g., corresponding to reception circuitry) receives, in a signal (e.g., DAI) indicating the number of data assignments in a retransmission process (e.g., HARQ process), information configured based on a configuration related to feedback (e.g., whether enabled or disabled) for the retransmission process. A controller (e.g., corresponding to control circuitry) controls the data reception based on the information.

### [Configuration of Base Station]

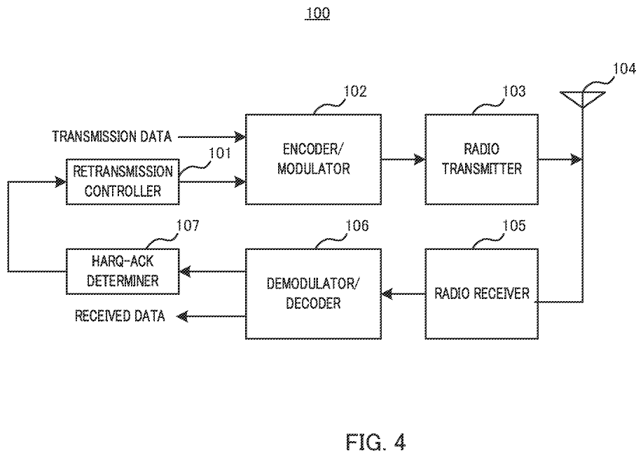

FIG. 4 is a block diagram illustrating an exemplary configuration of base station 100 according to the present embodiment. Base station 100 includes, for example, retransmission controller 101, encoder/modulator 102, radio transmitter 103, antenna 104, radio receiver 105, demodulator/decoder 106, and HARQ-ACK determiner 107.

For example, at least one of retransmission controller 101, encoder/modulator 102, demodulator/decoder 106, and HARQ-ACK determiner 107 illustrated in FIG. 4 may be included in the controller illustrated in FIG. 2. In addition, radio transmitter 103 illustrated in FIG. 4 may be included in the transmitter illustrated in FIG. 2, for example.

Retransmission controller 101, for example, controls retransmission of transmission data (e.g., PDSCH). For example, retransmission controller 101 may generate information on retransmission control including at least one of a HARQ process ID, NDI, RV, information indicating HARQ-ACK transmission timing (e.g., PDSCH-to-HARQ_feedback timing indicator), and DAI (C-DAI, T-DAI) for transmission data. Retransmission controller 101 outputs the generated information on retransmission control to encoder/modulator 102.

Here, for example, a HARQ-ACK feedback configuration (e.g., either feedback-enabled or feedback-disabled) and a HARQ process ID may be associated with each other in advance. Information on the association between the feedback configuration and the HARQ process ID may be indicated (or configured) to terminal 200 by, for example, higher layer signaling or downlink control information. Base station 100 may implicitly indicate either feedback-enabled or feedback-disabled to terminal 200 by indicating the HARQ process ID, for example. Note that the indication of the feedback configuration is not limited to the above example, and base station 100 may explicitly indicate information on the feedback configuration to terminal 200.

In addition, retransmission controller 101 may determine information to be configured to a DAI field for each HARQ process based on the HARQ-ACK feedback configuration for the HARQ process, for example. Exemplary methods of configuring DAI fields will be described later.

Further, for example, retransmission controller 101 may determine retransmission of transmission data (or transmission of new data) based on information inputted from HARQ-ACK determiner 107, and indicate whether retransmission of transmission data is performed to encoder/modulator 102.

For example, encoder/modulator 102 performs, on inputted transmission data (e.g., transport block), error correction coding such as turbo coding, LDPC coding, or polar coding, and modulation such as quarter phase shift keying (QPSK) or quadrature amplitude modulation (QAM), and outputs the modulated signal to radio transmitter 103.

Encoder/modulator 102 may, for example, store transmission data in a buffer. When retransmission controller 101 indicates retransmission, for example, encoder/modulator 102 may perform the same processing as described above on the transmission data (e.g., retransmission data) stored in the buffer. When retransmission controller 101 indicates no retransmission (or transmission of new data), for example, encoder/modulator 102 may delete corresponding transmission data stored in the buffer.

In addition, encoder/modulator 102, for example, encodes and modulates downlink control information (e.g., DCI) and outputs the modulated signal to radio transmitter 103. DCI may include, for example, data assignment information, such as time and frequency resource allocation information and information on a coding and modulation scheme (e.g., modulation and coding scheme (MCS) information), and information on retransmission control, such as a HARQ process ID. NDI. RV, PDSCH-to-HARQ_feedback timing indicator, or DAI (C-DAI, T-DAI) inputted from retransmission controller 101.

Here, in LTE and 5G NR, for example, the transmission data may correspond to PDSCH, and the data assignment information may correspond to DCI or PDCCH.

For example, radio transmitter 103 performs transmission processing such as D/A conversion, up-conversion, and amplification on the signal inputted from encoder/modulator 102, and transmits the radio signal after the transmission processing from antenna 104.

For example, radio receiver 105 performs reception processing such as down-conversion and A/D conversion on a data signal (e.g., PUSCH) and a control signal (e.g., HARQ-ACK information) from terminal 200 received via antenna 104, and outputs the signal after the reception processing to demodulator/decoder 106.

Demodulator/decoder 106 performs, for example, channel estimation, demodulation processing, and decoding processing on the received signal inputted from radio receiver 105. For example, demodulator/decoder 106 outputs received data when the received signal is data, and outputs HARQ-ACK information to HARQ-ACK determiner 107 when the received signal is HARQ-ACK information.

HARQ-ACK determiner 107, for example, determines whether there is an error (e.g., ACK or NACK) in each transmission data (e.g., transport block) that has been transmitted based on the HARQ-ACK information (e.g., HARQ-ACK codebook) inputted from demodulator/decoder 106. When the HARQ-ACK information is NACK, for example, HARQ-ACK determiner 107 may indicate retransmission of data to retransmission controller 101. When the HARQ-ACK information is ACK, for example, HARQ-ACK determiner 107 may indicate no retransmission of data to retransmission controller 101.

Note that, when the Type 2 HARQ-ACK codebook is configured to terminal 200, base station 100, for example, receives HARQ-ACK of the feedback-enabled HARQ process and does not receive HARQ-ACK of the feedback-disabled HARQ process. For example, HARQ-ACK determiner 107 may determine whether there is an error for the HARQ-ACK of the feedback-enabled HARQ process. Here, for example, which type of HARQ-ACK codebook is applied to each HARQ process may be indicated (or configured) in advance to terminal 200.

### [Configuration of Terminal]

Next, an exemplary configuration of terminal 200 will be described.

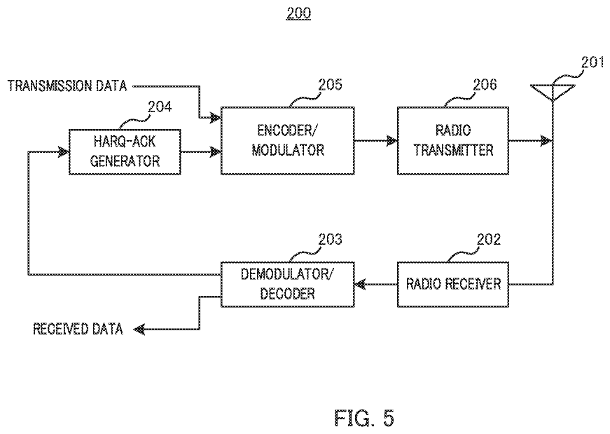

FIG. 5 is a block diagram illustrating an exemplary configuration of terminal 200 according to the present embodiment. Terminal 200 includes, for example, antenna 201, radio receiver 202, demodulator/decoder 203, HARQ-ACK generator 204, encoder/modulator 205, and radio transmitter 206.

For example, at least one of demodulator/decoder 203. HARQ-ACK generator 204, and encoder/modulator 205 illustrated in FIG. 5 may be included in the controller illustrated in FIG. 3. In addition, radio receiver 202 illustrated in FIG. 5 may be included in the receiver illustrated in FIG. 3, for example.

For example, radio receiver 202 performs reception processing such as down-conversion and A/D conversion on a data signal (e.g., PDSCH) and a control signal (e.g., PDCCH or DCI) from base station 100 received via antenna 201, and outputs the signal after the reception processing to demodulator/decoder 203.

Demodulator/decoder 203 performs, for example, channel estimation, demodulation processing, and decoding processing on the received signal inputted from radio receiver 202. For example, when the received signal is data, demodulator/decoder 203 may perform processing based on data assignment information (e.g., modulation scheme and coding rate) included in the control signal. Demodulator/decoder 203 may determine whether the received data is initial transmission data (or new data) or retransmission data, for example, based on NDI included in the control signal. In a case of initial transmission data, for example, demodulator/decoder 203 may perform error correction decoding and cyclic redundancy check (CRC) determination. In a case of retransmission data, for example, demodulator/decoder 203 may perform error correction decoding after combining the data stored in a buffer with the received data, and perform CRC determination. For example, demodulator/decoder 203 outputs the CRC determination result to HARQ-ACK generator 204.

HARQ-ACK generator 204 generates HARQ-ACK information (e.g., HARQ-ACK codebook) based on the CRC determination result inputted from demodulator/decoder 203, for example, and outputs the generated information to encoder/modulator 205.

HARQ-ACK generator 204 generates HARQ-ACK information (e.g., ACK or NACK) based on the CRC determination result, for example, for data of feedback-enabled HARQ process. For example, HARQ-ACK generator 204 generates ACK in a case of CRC OK (e.g., no error) and generates NACK in a case of CRC NG (Not Good, e.g., with error). In addition, when terminal 200 receives a plurality of transport blocks or code blocks, for example, HARQ-ACK generator 204 may generate HARQ-ACK for each of the plurality of transport blocks or code blocks and generate a HARQ-ACK code block composed of the plurality of HARQ-ACKs.

When the Type 1 HARQ-ACK codebook is configured, HARQ-ACK generator 204 may insert NACK into the HARQ-ACK codebook for slots and CCs with no data assignment, or for data of the feedback-disabled HARQ process, for example, regardless of a CRC decoding result.

When the Type 2 HARQ-ACK codebook is configured, HARQ-ACK generator 204 need not include HARQ-ACK in the HARQ-ACK codebook for slots and CCs with no data assignment, or for data of the feedback-disabled HARQ process, for example. In other words, HARQ-ACK generator 204 may include HARQ-ACK in the HARQ-ACK codebook, for slots and CCs with data assignment, or for data of the feedback-enabled HARQ process, for example.

For example, encoder/modulator 205 performs error correction coding and modulation processing on inputted transmission data (e.g., transport block), and outputs the modulated signal to radio transmitter 206. Encoder/modulator 205 also performs error correction coding and modulation processing on the HARQ-ACK information inputted from HARQ-ACK generator 204, for example, and outputs the modulated signal to radio transmitter 206.

For example, radio transmitter 206 performs transmission processing such as D/A conversion, up-conversion, and amplification on the signal inputted from encoder/modulator 205, and transmits the radio signal after the transmission processing from antenna 201.

Here, terminal 200 may transmit the HARQ-ACK information at a timing based on the PDSCH-to-HARQ_feedback timing indicator included in a control signal from base station 100, for example. In addition, terminal 200 may configure the size of the HARQ-ACK codebook, for example, based on DAI (C-DAI. T-DAI) included in the last received DCI among DCI assigning PDSCHs for HARQ-ACK transmission timings.

### [Exemplary Operations of Base Station and Terminal]

Next, exemplary operations of base station 100 and terminal 200 will be described.

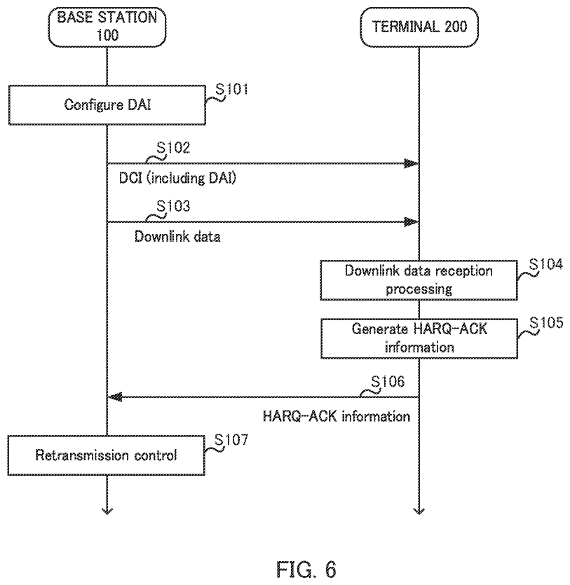

FIG. 6 is a sequence diagram describing exemplary operations of base station 100 and terminal 200 in the present embodiment.

In FIG. 6, base station 100 configures DAI (e.g., C-DAI and T-DAI) based on, for example, assignment of downlink data (e.g., PDSCH) for terminal 200 (S101). Base station 100 may determine, for example, information to be configured to a DAI field in a HARQ process for the assignment of PDSCH based on a configuration related to each feedback (e.g., either feedback-enabled or feedback-disabled) of the HARQ process. Exemplary configurations of DAI will be described later.

Base station 100 transmits, for example, DCI including DAI to terminal 200 (S102). Terminal 200 receives the DCI including DAI from base station 100.

Base station 100 transmits downlink data to terminal 200 (S103), for example. Terminal 200 may receive the downlink data, for example, based on data assignment information included in the DCI.

Terminal 200 may perform reception processing, such as error correction decoding and CRC determination, on the received downlink data (S104). For example, terminal 200 may control the reception processing (e.g., determination of the size of a HARQ-ACK codebook) for the downlink data (e.g., data for a feedback-disabled HARQ process) based on a DAI (e.g., at least one of C-DAI and T-DAI) for the feedback-disabled HARQ process.

Terminal 200 may generate HARQ-ACK information based on, for example, a result of the downlink data reception processing (e.g., CRC determination result) (S105). For example, terminal 200 may generate a HARQ-ACK codebook including HARQ-ACK for downlink data for a feedback-enabled HARQ process. In other words, terminal 200 need not include HARQ-ACK information for downlink data for a feedback-disabled HARQ process in a HARQ-ACK codebook.

Terminal 200 transmits the generated HARQ-ACK information (e.g., HARQ-ACK codebook) to base station 100 (S106).

Base station 100 performs retransmission control based on the HARQ-ACK information transmitted from terminal 200 (S107).

Next, methods of configuring DAI according to the present embodiment (e.g., exemplary information configured to a DAI field) will be described. In the following, Configuration Method 1 to Configuration Method 4 will be each described, by way of example.

### <Configuration Method 1>

In Configuration Method 1, a C-DAI field in DCI assigning a feedback-enabled HARQ process may include, as specified in NR Rel. 15/16, a C-DAI value indicating a count value of slots and CCs with data assignment (or a count value of the number of data assignments) until the slot and CC in which the DAI is indicated, for example. Further, in Configuration Method 1, a T-DAI field in DCI assigning a feedback-enabled HARQ process may include, as specified in NR Rel. 15/16, a T-DAI value indicating the total number of data assignments until the slot in which the DAI is indicated, for example.

Furthermore, in Configuration Method 1, a C-DAI field and T-DAI field in DCI assigning a feedback-disabled HARQ process may each include a C-DAI value and a T-DAI value, as in the case of the feedback-enabled HARQ process, for example.

The C-DAI value and T-DAI value in this case may be, for example, values that do not count (i.e., do not include) data assignment in the feedback-disabled HARQ process.

For example, base station 100 may configure information on the number of data assignments in the feedback-enabled HARQ process (e.g., C-DAI and T-DAI values) to signals (e.g., C-DAI and T-DAI fields) for the feedback-disabled HARQ process. For example, the C-DAI field and T-DAI field in DCI assigning the feedback-disabled HARQ process may be configured with a C-DAI value and T-DAI value in the feedback-enabled HARQ process immediately before the assignment of the feedback-disabled HARQ process.

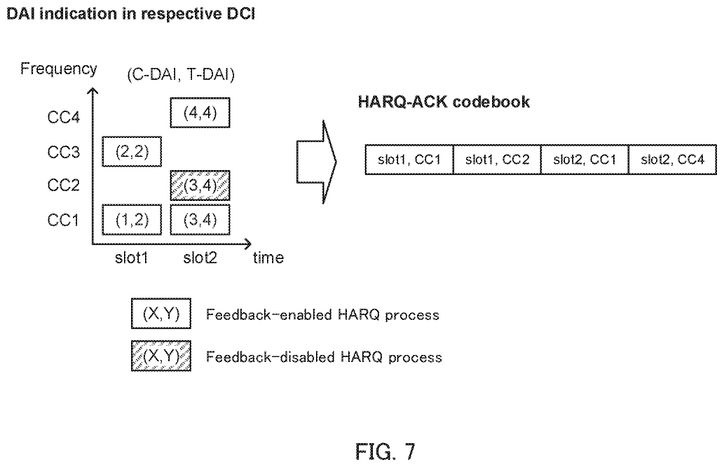

FIG. 7 illustrates exemplary DAI fields and an exemplary HARQ-ACK codebook according to Configuration Method 1.

In the example illustrated in FIG. 7, DCI assigning a feedback-enabled HARQ process is transmitted and received in CC1 and CC3 of slot1 and CC1 and CC4 of slot2, and DCI assigning a feedback-disabled HARQ process is transmitted and received in CC2 of slot2.

As illustrated in FIG. 7, base station 100 may configure, in the DCI assigning a feedback-enabled HARQ process, the C-DAI value indicating a count value (or cumulative number) of data assignments for each CC and each slot (i.e., each pair of CC and slot) and the T-DAI value indicating the total number of data assignments for each slot.

Here, base station 100 need not count the data assignment for the feedback-disabled HARQ process in configuring the C-DAI value of DCI assigning a feedback-enabled HARQ process, for example. In addition, base station 100 need not count the data assignment for the feedback-disabled HARQ process in configuring the T-DAI value of DCI assigning a feedback-enabled HARQ process, for example. In other words, base station 100 may count the data assignments except for the data assignment for the feedback-disabled HARQ process in configuring the C-DAI and T-DAI values in a feedback-enabled HARQ process.

For example, in FIG. 7, in DCI assigning a feedback-enabled HARQ process, the T-DAI value may be set to 2 in slot1, and the T-DAI value may be set to 4 in slot2 without counting the assignment of the feedback-disabled HARQ process in CC2 of slot2. Also, in FIG. 7, for example, in DCI assigning a feedback-enabled HARQ process, the C-DAI value may be set without counting (i.e., without incrementing) the assignment of the feedback-disabled HARQ processes in CC2 of slot2.

Meanwhile, base station 100 may set the same value as the C-DAI and T-DAI values of a feedback-enabled HARQ process, for example, in the C-DAI and T-DAI fields of the DCI assigning the feedback-disabled HARQ process without counting the assignment of that HARQ process. For example, in FIG. 7, the C-DAI and T-DAI values in CC2 of slot2 may be set to (3, 4), which is the same as the C-DAI and T-DAI values in the previous assignment in CC1 of slot2.

Terminal 200 need not include, for example, HARQ-ACK for the feedback-disabled HARQ process in a HARQ-codebook. Meanwhile, terminal 200 may determine the size of the HARQ-codebook including HARQ-ACKs for the feedback-enabled HARQ processes, for example, based on information of the C-DAI and T-DAI fields of DAI included in the DCI assigning the feedback-disabled HARQ process.

By way of example, a description will be given of a case where terminal 200 fails to receive DCI in CC1 of slot2 in FIG. 7. In this case, terminal 200 can determine that a DCI reception failure has occurred in CC1 of slot2 where data in the feedback-enabled HARQ process is assigned, based on, for example, DAI (3, 4) of the feedback-disabled HARQ process received in CC2 of slot2. In other words, terminal 200 can determine that there is an assignment of the feedback-enabled HARQ process in CC1 of slot2 based on the DAI (3, 4) received in CC2 of slot2. Thus, as illustrated in FIG. 7, terminal 200 can determine the size of the HARQ-ACK codebook including four feedback-enabled HARQ-ACK bits.

As described above, even in the case of reception failure (or reception error) of DCI assigning a feedback-enabled HARQ process, for example, Configuration Method 1 possibly allows terminal 200 to determine the size of a HARQ-codebook based on information configured in C-DAI and T-DAI fields (e.g., C-DAI and T-DAI values) of DCI assigning a feedback-disabled HARQ process. This reduces the probability of disagreement in HARQ-codebook size recognition between base station 100 and terminal 200.

In addition, according to Configuration Method 1, the same DCI size can be configured between DCI assigning a feedback-disabled HARQ process and DCI assigning a feedback-enabled HARQ process, thus reducing the increase in the number of times of blind decoding during PDCCH reception at terminal 200.

### <Configuration Method 2>

In Configuration Method 2, C-DAI and T-DAI fields of DCI assigning a feedback-disabled HARQ process may be reserved. In other words, base station 100 need not configure C-DAI and T-DAI values (e.g., information on the number of PDSCH assignments) in the C-DAI and T-DAI fields of the DAI for a feedback-disabled HARQ process, for example.

For example, base station 100 may configure information other than the DAI values (e.g., information on the number of PDSCH assignments) in the C-DAI and T-DAI fields (e.g., fields where no DAI values are configured) for a feedback-disabled HARQ process. Note that exemplary usages of the C-DAI field and T-DAI field of DCI assigning a feedback-disabled HARQ process will be described later.

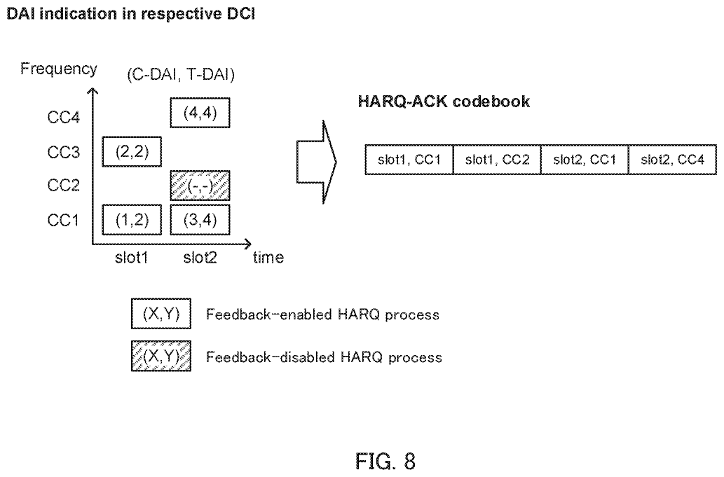

FIG. 8 illustrates exemplary DAI fields and an exemplary HARQ-ACK codebook according to Configuration Method 2.

As illustrated in FIG. 8, base station 100 need not count the data assignment for a feedback-disabled HARQ process, as in Configuration Method 1, in configuring the C-DAI and T-DAI values of DCI assigning a feedback-enabled HARQ process, for example. For example, in the exemplary assignment illustrated in FIG. 8. T-DAI may be set to 4 in DAI included in DCI indicated in slot2 without counting the assignment in CC2 of slot2.

In addition, as illustrated in FIG. 8, base station 100, for example, need not configure (or indicate) DAI values (e.g., C-DAI and T-DAI values) in the C-DAI and T-DAI fields included in DAI in DCI assigning a feedback-disabled HARQ process (e.g., DCI in CC2 of slot2). For example, in the DCI in CC2 of slot2 in FIG. 8, the C-DAI field and T-DAI field may be configured with specified values (e.g., 0 for all) or information for another application other than the information on the number of data assignments.

Terminal 200 may, for example, ignore values in the DAI field included in DCI assigning a feedback-disabled HARQ process. In other words, terminal 200 may perform processing on HARQ-ACK (e.g., determining the size of a HARQ-ACK codebook) based on, for example, values in DAI fields included in DCI assigning feedback-enabled HARQ processes.

In addition, terminal 200 may use, for example, values set to the C-DAI and T-DAI fields (e.g., reserved fields) included in DCI assigning a feedback-disabled HARQ process for an application other than the application related to indication of the number of the downlink data assignments, as described later.

For example, in Configuration Method 2, a specified value (e.g., known information between base station 100 and terminal 200) may be set (or inserted) in at least a part of the C-DAI and T-DAI fields in a DAI field (e.g., field where no DAI value is set) for a feedback-disabled HARQ process. For example, terminal 200 may use the specified value as a virtual CRC. The virtual CRC reduces CRC determination errors in terminal 200.

Alternatively, for example, in Configuration Method 2, a parameter related to data transmission in a feedback-disabled HARQ process may be set in at least a part of the C-DAI and T-DAI fields in the DAI field (e.g., field where no DAI value is set) for a feedback-disabled HARQ process, as described later. This allows base station 100 to indicate the parameter related to data transmission to terminal 200 while preventing the increase in DCI size.

In addition, according to Configuration Method 2, the same DCI size can be configured between DCI assigning a feedback-disabled HARQ process and DCI assigning a feedback-enabled HARQ process, thus reducing the increase in the number of times of blind decoding during PDCCH reception at terminal 200.

### <Configuration Method 3>

In Configuration Method 3, a C-DAI field of DCI assigning a feedback-disabled HARQ process may be reserved, and a T-DAI field may include a T-DAI value indicating the total number of data assignments until the slot in which the DAI is indicated. In other words, base station 100, for example, need not configure a C-DAI value in some field (e.g., C-DAI field) of DAI for a feedback-disabled HARQ process, and may configure a T-DAI value for a feedback-enabled HARQ process in another field (e.g., T-DAI field).

For example, base station 100 may configure information other than the C-DAI value in the C-DAI field (e.g., field where no DAI value is set) for a feedback-disabled HARQ process. Note that exemplary usages of the C-DAI field of DCI assigning a feedback-disabled HARQ process will be described later.

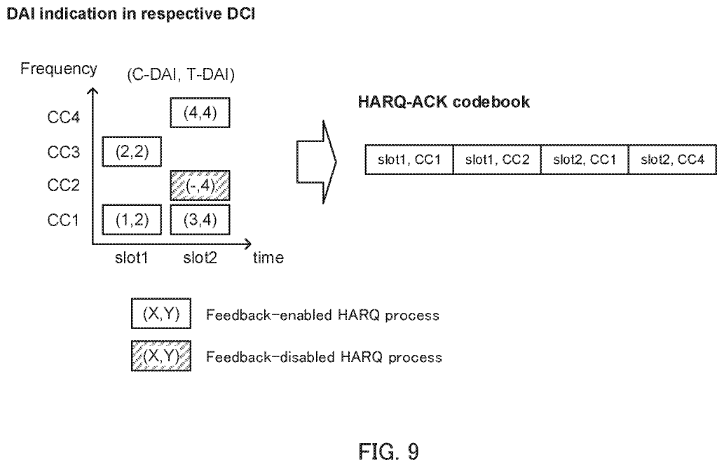

FIG. 9 illustrates exemplary DAI fields and an exemplary HARQ-ACK codebook according to Configuration Method 3.

As illustrated in FIG. 9, base station 100 need not count the data assignment for a feedback-disabled HARQ process, as in Configuration Method 1, in configuring the T-DAI value in the T-DAI field of DCI assigning a feedback-enabled HARQ process, for example. For example, in the exemplary assignment illustrated in FIG. 9, T-DAI may be set to 4 in DAI included in DCI indicated in slot2 without counting the assignment in CC2 of slot2.

In addition, as illustrated in FIG. 9, base station 100 need not configure (or indicate) the C-DAI value in the C-DAI field included in DCI assigning a feedback-disabled HARQ process (e.g., DCI in CC2 of slot2), for example. For example, in the DCI in CC2 of slot2 in FIG. 9, the C-DAI field may be configured with a specified value (e.g., 0 for all) or information for another application other than the information on the number of data assignments.

Meanwhile, as illustrated in FIG. 9, base station 100, for example, may configure the T-DAI value for a feedback-enabled HARQ process in the T-DAI field included in DCI assigning a feedback-disabled HARQ process (e.g., DCI in CC2 of slot2). For example, base station 100 may set T-DAI=4 in the T-DAI field of DAI in the HARQ process in CC2 of slot2 illustrated in FIG. 9 without counting the assignment of that HARQ process. For example, in FIG. 9, the same value as the T-DAI value in CC1 of slot2, which is immediately prior assignment, may be set as the T-DAI value in the T-DAI field in CC2 of slot2.

Terminal 200 may, for example, ignore a value in the C-DAI field included in DCI assigning a feedback-disabled HARQ process. In other words, terminal 200 may perform processing on HARQ-ACK (e.g., determining the size of a HARQ-ACK codebook) based on, for example, values in DAI fields included in DCI assigning feedback-enabled HARQ processes and a value in the T-DAI field included in DCI assigning a feedback-disabled HARQ process.

In addition, terminal 200 may use, for example, a value set to the C-DAI field (e.g., reserved field) included in DCI assigning a feedback-disabled HARQ process for an application other than the application related to indication of the number of the downlink data assignments, as described later.

For example, in Configuration Method 3, a specified value (e.g., known information between base station 100 and terminal 200) may be set (or inserted) in at least a part of the C-DAI field (e.g., field where no DAI value is set) for a feedback-disabled HARQ process. For example, terminal 200 may use the specified value as a virtual CRC. The virtual CRC reduces CRC determination errors in terminal 200.

Alternatively, for example, in Configuration Method 3, a parameter related to data transmission in a feedback-disabled HARQ process may be set in at least a part of the C-DAI field (e.g., field where no DAI value is set) for a feedback-disabled HARQ process, as described later. This allows base station 100 to indicate the parameter related to data transmission to terminal 200 while preventing the increase in DCI size. Since a specified number of bits (e.g., 2 bits in NR Rel. 15/16) is set in the C-DAI field regardless of the number of CCs configured to terminal 200, for example, the parameter related to data transmission can be indicated in the C-DAI field regardless of a configuration of the number of CCs.

In addition, Configuration Method 3 allows terminal 200 to determine the size of a HARQ-codebook, for example, based on information (e.g., T-DAI value) configured in the T-DAI field of DCI assigning a feedback-disabled HARQ process. Thus, even in the case of reception failure (or reception error) of DCI assigning a feedback-enabled HARQ process, for example, terminal 200 can possibly determine the size of a HARQ-ACK codebook based on a value in the T-DAI field of DCI assigning a feedback-disabled HARQ process. This reduces the probability of disagreement in HARQ-ACK codebook size recognition between base station 100 and terminal 200.

For example, a T-DAI value indicates the total number of data assignments until the slot in which the T-DAI value is indicated (e.g., value that may correspond to the HARQ-ACK codebook size), as described above, and thus the T-DAI value is useful for determining the HARQ-ACK codebook size compared with the C-DAI. For example, in the example of FIG. 9, even when terminal 200 fails to receive DCI in at least one of CC1 and CC4 of slot2, terminal 200 can determine that the total number of data assignments until slot2 is four based on the DAI (-, 4) received in CC2 of slot2, thereby determining the size of the HARQ-ACK codebook including four feedback-enabled HARQ-ACKs.

In addition, according to Configuration Method 3, the same DCI size can be configured between DCI assigning a feedback-disabled HARQ process and DCI assigning a feedback-enabled HARQ process, thus reducing the increase in the number of times of blind decoding during PDCCH reception at terminal 200.

### <Configuration Method 4>

In Configuration Method 4, the C-DAI field of DCI assigning a feedback-disabled HARQ process includes a C-DAI value indicating the number of data assignments (e.g., cumulative number) until the slot and CC in which the DAI is indicated, and the T-DAI field may be reserved. In other words, base station 100, for example, need not configure a T-DAI value in some field (e.g., T-DAI field) of DAI for a feedback-disabled HARQ process, and may configure a C-DAI value for a feedback-enabled HARQ process in another field (e.g., C-DAI field).

For example, base station 100 may configure information other than a T-DAI value in the T-DAI field (e.g., field where no DAI value is set) for a feedback-disabled HARQ process. Note that exemplary usages of the T-DAI field of DCI assigning a feedback-disabled HARQ process will be described later.

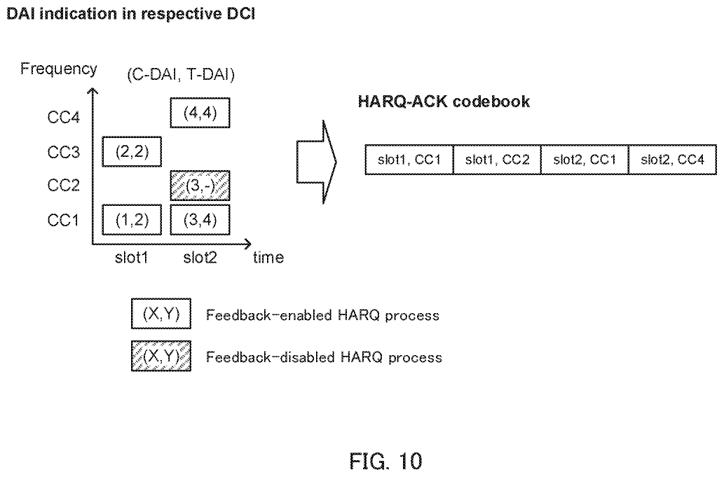

FIG. 10 illustrates exemplary DAI fields and an exemplary HARQ-ACK codebook according to Configuration Method 4.

As illustrated in FIG. 10, base station 100 need not count the data assignment for a feedback-disabled HARQ process, as in Configuration Method 1, in configuring the C-DAI value in the C-DAI field of DCI assigning a feedback-enabled HARQ process, for example. For example, in the exemplary assignment illustrated in FIG. 10, C-DAI may be set to 3 and 4 in respective DAIs included in DCI indicated in slot2 without counting the assignment in CC2 of slot2.

In addition, as illustrated in FIG. 10, base station 100 need not configure (or indicate) the T-DAI value in the T-DAI field included in DCI assigning a feedback-disabled HARQ process (e.g., DCI in CC2 of slot2), for example. For example, in the DCI in CC2 of slot2 in FIG. 10, the T-DAI field may be configured with specified value (e.g., 0 for all) or information for another application other than the information on the number of data assignments.

Meanwhile, as illustrated in FIG. 10, base station 100, for example, may configure the C-DAI value for a feedback-enabled HARQ process in the C-DAI field included in DCI assigning a feedback-disabled HARQ process (e.g., DCI in CC2 of slot2). For example, base station 100 may set C-DAI=3 in the C-DAI field of DAI in the HARQ process in CC2 of slot2 illustrated in FIG. 10 without counting the assignment of that HARQ process. For example, in FIG. 10, the same value as the C-DAI value in CC1 of slot2, which is immediately prior assignment, may be set as the C-DAI value in the C-DAI field in CC2 of slot2.

Terminal 200 may, for example, ignore a value in the T-DAI field included in DCI assigning a feedback-disabled HARQ process. In other words, terminal 200 may perform processing on HARQ-ACK (e.g., determining the size of a HARQ-ACK codebook) based on, for example, values in DAI fields included in DCI assigning feedback-enabled HARQ processes and a value in the C-DAI field included in DCI assigning a feedback-disabled HARQ process.

In addition, terminal 200 may use, for example, values set to the T-DAI field (e.g., reserved field) included in DCI assigning a feedback-disabled HARQ process for an application other than the application related to indication of the number of the downlink data assignments, as described later.

For example, in Configuration Method 4, a specified value (e.g., known information between base station 100 and terminal 200) may be set (or inserted) in at least a part of the T-DAI field (e.g., field where no DAI value is set) for a feedback-disabled HARQ process. For example, terminal 200 may use the specified value as a virtual CRC. The virtual CRC reduces CRC determination errors in terminal 200.

Alternatively, for example, in Configuration Method 4, a parameter related to data transmission in a feedback-disabled HARQ process may be set in at least a part of the T-DAI field (e.g., field where no DAI value is set) for a feedback-disabled HARQ process, as described later. This allows base station 100 to indicate the parameter related to data transmission to terminal 200 while preventing the increase in DCI size.

In addition, Configuration Method 4 allows terminal 200 to determine the size of a HARQ-codebook, for example, based on information (e.g., C-DAI value) configured in the C-DAI field of DCI assigning a feedback-disabled HARQ process. Thus, even in the case of reception failure (or reception error) of DCI assigning a feedback-enabled HARQ process, for example, terminal 200 can possibly determine the size of a HARQ-ACK codebook based on a value in the C-DAI field of DCI assigning a feedback-disabled HARQ process. This reduces the probability of disagreement in HARQ-ACK codebook size recognition between base station 100 and terminal 200.

For example, in the example of FIG. 10, even when terminal 200 fails to receive DCI in CC1 of slot2, terminal 200 can determine that the number of data assignments until slot2 is three based on the DAI (3, -) received in CC2 of slot2, and thus the HARQ-ACK codebook size can possibly be determined.

In addition, according to Configuration Method 4, the same DCI size can be configured between DCI assigning a feedback-disabled HARQ process and DCI assigning a feedback-enabled HARQ process, thus reducing the increase in the number of times of blind decoding during PDCCH reception at terminal 200.

Exemplary DAI configuration methods have been described, thus far.

Next, examples will be described in which information used for an application other than indication of information on the number of data assignments is configured in at least some (e.g., field in which no DAI value is configured) of the C-DAI field and the T-DAI field in the above-described Configuration Methods 2, 3, and 4, for example.

For example, data transmission in a feedback-disabled HARQ process does not yield retransmission gain and combined gain from HARQ; accordingly, transmission based on more robust transmission parameters or transmission parameters that achieve a lower error rate (e.g., block error rate (BLER)) is expected compared to data transmission in a feedback-enabled HARQ process.

In the following, usages 1 to 4 of a field reserved in DAI of DCI assigning a feedback-disabled HARQ process will be each described.

### <Usage 1>

In Usage 1, a field reserved in DAI may be configured with a parameter on the number of repeated transmissions (or the number of repetitions) in data transmission in a feedback-disabled HARQ process, for example.

For example, in a feedback-enabled HARQ process, terminal 200 may use the number of repetitions indicated (or configured) by “pdsch-AggregationFactor” or “repetitionNumber”, which are higher layer parameters (e.g., RRC parameters).

Meanwhile, in a feedback-disabled HARQ process, for example, terminal 200 may use the number of repetitions indicated (or configured) in a DAI field (e.g., at least one of a C-DAI field and a T-DAI field). The number of repetitions indicated by a DAI field may be, for example, any one of a plurality of candidates for the number of repetitions separately configured to terminal 200 by an RRC parameter, or may be the number of repetitions other than the plurality of candidates configured to terminal 200 by the RRC parameter.

For example, the number of repetitions indicated by a DAI field may be configured to be greater than the number of repetitions configured to a feedback-enabled HARQ process. This achieves a lower BLER even without retransmission by HARQ in transmission by a feedback-disabled HARQ process.

### <Usage 2>

In Usage 2, a field reserved in DAI may be configured with a parameter on the MCS level used for data transmission in a feedback-disabled HARQ process, for example.

In NR, for example, a plurality of MCS tables (e.g., MCS index tables) are specified as described in section 5.1.3 of NPL 3. For example, NPL 3 specifies “Table 1” specifying the MCS level (e.g., modulation order) up to 64 QAM, “Table 2” specifying the MCS level up to 256 QAM, and “Table 3” specifying the MCS level up to 64 QAM and the MCS level with a coding rate lower than that in Table 1.

A field reserved in DAI may be configured with, for example, a parameter indicating any one of Tables 1 to 3. For example, in a feedback-disabled HARQ process, terminal 200 may determine the MCS level (e.g., modulation scheme and coding rate) based on the MCS table indicated (or configured) in a DAI field (e.g., at least one of a C-DAI field and a T-DAI field).

Alternatively, the field reserved in DAI may be configured with, for example, a parameter related to an MCS level other than the MCS levels specified in Tables 1 to 3. For example, the field reserved in DAI may be configured with a parameter related to an MCS level with a coding rate (or spectral efficiency) lower than the MCS level specified in the MCS table (e.g., any one of Tables 1 to 3) configured to terminal 200. By way of example, the field reserved in DAI may be configured with a value of 2 bits indicating a ratio (e.g., any one of 1/2, 1/4, 1/8, and 1/16) to a coding rate (or spectral efficiency) of the MCS level (e.g., lowest MCS level) of any one of the MCS tables configured to terminal 200. Note that the number of bits of the value indicating the ratio to the coding rate is not limited to 2 bits.

For example, configuring an MCS level lower than the MCS level configured to terminal 200 by a DAI field achieves a lower BLER even without retransmission by HARQ in transmission by a feedback-disabled HARQ process.

### <Usage 3>

For example, a method for achieving a lower BLER in transmission by a feedback-disabled HARQ process may include a method in which base station 100 transmits the same data (e.g., PDSCH) a plurality of times by blind retransmission. In the blind retransmission, for example, base station 100 transmits retransmission data to terminal 200 without receiving HARQ-ACK from terminal 200. Here, terminal 200 may determine whether the transmission data is initially (or newly) transmitted or retransmitted, for example, based on a bit of NDI included in DCI for data assignment.

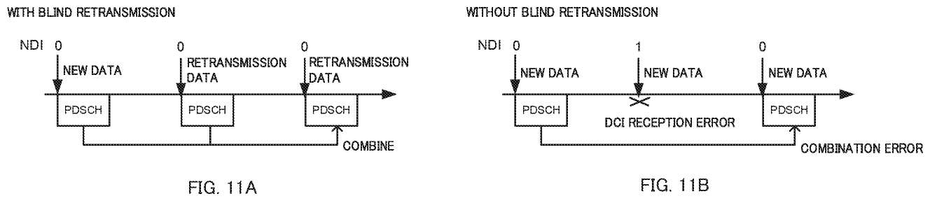

FIG. 11 illustrate an exemplary case with blind retransmission (FIG. 11A) and an exemplary case without blind retransmission (FIG. 11B).

In the case with blind retransmission as illustrated in FIG. 11A, for example, when the second and third data (e.g., retransmission data) are transmitted, NDI may be configured to be the same value (0 in FIG. 11A) as the NDI value for transmission of the first data (e.g., new data) (i.e., no toggle or no increment), and the NDI may be indicated to terminal 200. In FIG. 11A, since the corresponding NDI is not toggled when receiving the second and third data, terminal 200, for example, may determine that the data is retransmission data and perform decoding by combining the retransmission data and the previously received data.

Meanwhile, in the case without blind retransmission as illustrated in FIG. 11B, for example, when the second and third data (e.g., new data) are transmitted, the NDI value previously indicated is toggled (or incremented) and indicated to terminal 200. NDI has 1 bit in FIG. 11B, for example, and when the second data (e.g., new data) is transmitted, a value other than the NDI for transmission of the first data (1 in FIG. 11B) is indicated to terminal 200. When the third data (e.g., new data) is transmitted, a value other than the NDI for transmission of the second data, that is, the same value as the NDI for transmission of the first data (0 in FIG. 11B) is indicated to terminal 200.

Here, when DCI reception error (or decoding error) for the second data occurs in terminal 200 as illustrated in FIG. 11B, terminal 200 does not recognize the NDI (e.g., NDI=1) for the second data. In this case, for example, NDI=0 (e.g., the same value as the NDI for the first data) is indicated in DCI for the third data, and thus terminal 200 determines that transmission of the third data is retransmission of the first data and erroneously combines the third data with the first data. This results in combination of different data since the first data and the third data are different as illustrated in FIG. 11B, thereby easily causing a data decoding error in terminal 200.

In Usage 3, a field reserved in DAI may be configured with a parameter on blind retransmission in a feedback-disabled HARQ process, for example. The field reserved in DAI may be configured with a parameter indicating whether assigned data is retransmission data (e.g., an extended DAI or a retransmission indication bit to be described later), for example.

By way of example, an NDI field may be extended using the reserved field of DAI. For example, 1 bit of the reserved field of DAI (e.g., at least one of a C-DAI field and a T-DAI field) may be added to NDI and combined with 1 bit of the NDI field, and a total of 2 bits of NDI may be indicated to terminal 200.

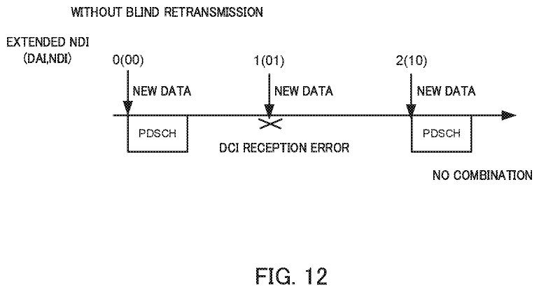

FIG. 12 illustrates an exemplary case without blind retransmission in Usage 3. In the example illustrated in FIG. 12, 2 bits of an extended NDI (e.g., any one of 0 (bit string: 00), 1 (bit string: 01), 2 (bit string: 10), and 3 (bit string: 11, which is not illustrated)) composed of 1 bit of the DAI field and 1 bit of the NDI field may be indicated to terminal 200.

For example, as illustrated in FIG. 12, when the second and third data (e.g., PDSCH) are transmitted, the NDI value previously indicated is toggled (or incremented) and indicated to terminal 200. The extended NDI has 2 bits in FIG. 12, for example, and when the second data (e.g., new data) is transmitted, a value (2 (bit string: 10) in FIG. 12) other than the NDI (e.g., 0 (bit string: 00)) for transmission of the first data may be indicated to terminal 200. Further, as illustrated in FIG. 12, when the third data (e.g., new data) is transmitted, a value (2 (bit string: 10) in FIG. 12) other than the NDIs (e.g., 0 (bit string: 00) and 1 (bit string: 01)) for transmission of the first and second data may be indicated to terminal 200.

Even when a DCI reception error (or decoding error) for the second data occurs in terminal 200 in FIG. 12, the NDI of the first data (=0) and the NDI of the third data (=2) are different from each other; accordingly, terminal 200 determines that the first data and the third data are different data and receives the new data without combining them, for example. As described above, the extended NDI can prevent a combination error in terminal 200.

Note that the number of bits of a DAI field included in the extended NDI is not limited to 1 bit and may be 2 bits or more. For example, two bits of either C-DAI or T-DAI may be added to NDI, and a total of 3 bits of extended NDI combined with 1 bit of the NDI field may be indicated to terminal 200. Alternatively, a total of 4 bits of C-DAI and T-DAI may be added to NDI, and a total of 5 bits of extended NDI combined with 1 bit of the NDI field may be indicated to terminal 200.

As another example, in the reserved field of DAI, a parameter indicating whether it is retransmission of transmission data (e.g., “retransmission indication bit”) may be indicated separately from NDI.

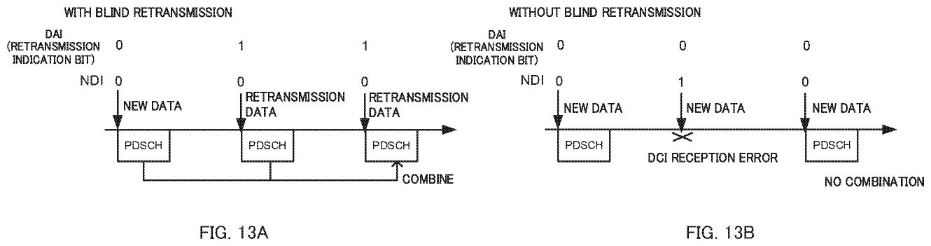

FIG. 13 illustrate examples in which 1 bit of the field reserved in DAI is used for the retransmission indication bit. FIG. 13A illustrates a case with blind retransmission, and FIG. 11B illustrates a case without blind retransmission.

For example, as illustrated in FIG. 13A and FIG. 13B, the DAI retransmission indication bit being 0 may indicate new data, and the retransmission indication bit being 1 may indicate retransmission data.

For example, a description will be given of a case where a DCI reception error (or decoding error) for the second data occurs in terminal 200 without blind retransmission as illustrated in FIG. 13B. In this case, terminal 200 may erroneously determine that the third data is retransmission data of the first data when based on the NDI value as described above. Even in this case, terminal 200 can correctly determine that the third data is new data based on the DAI retransmission indication bit (0 in FIG. 13B). As described above, the DAI retransmission indication bit can prevent a combination error in terminal 200.

Note that the blind retransmission is sometimes referred to as HARQ retransmission without feedback.

### <Usage 4>

In Usage 4, a field reserved in DAI may be configured with a parameter on the transmit power level used for data transmission in a feedback-disabled HARQ process, for example.

For example, the field reserved in DAI may be configured with a parameter on the power level of data (e.g., PDSCH) or a parameter on the power difference between a reference signal and data. The field reserved in DAI may also be configured with a transmit power control command.

Indication of the parameter on the transmit power level allows base station 100 to, for example, perform transmission by increasing the power of data or a reference signal at the time of transmission in a feedback-disabled HARQ process, thereby achieving transmission at lower BLER.

Exemplary usages of a field reserved in DAI have been described, thus far.

By using a DAI field of DCI assigning a feedback-disabled HARQ process for indication of a parameter for transmission by the feedback-disabled HARQ process, it is not necessary to add an indication bit to DCI for indicating the parameter, and a required BLER can be achieved.

Note that the application of the field reserved in DAI is not limited to the above-described usages, and it may be used for other applications.

For example, the field reserved in DAI may be configured with a parameter on a reference signal pattern or whether a reference signal is added. This allows more reference signals to be transmitted while transmission in a feedback-disabled HARQ process, thereby achieving transmission at lower BLER.

For example, parameters related to at least two usages (i.e., applications) among the above-described DAI field usages 1 to 4 may be indicated in the reserved field. By way of example, in a 4-bit DAI field, the number of repetitions may be indicated by 2 bits, and NDI bits (e.g., extended NDI bits) may be indicated by the other 2 bits. In addition, some bits of a C-DAI field or a T-DAI field (e.g., 2 bits in the 4-bit field) may be used for indicating a DAI value or information other than a DAI value as in Usages 1 to 4, and the remaining bits may be reserved.

The exemplary operations of base station 100 and terminal 200 have been described, thus far.

In the present embodiment, base station 100 determines information to be configured to DAI (e.g., C-DAI field and T-DAI field) indicating the number of data assignments in a HARQ process based on a configuration related to feedback (e.g., either enabled or disabled) for the HARQ process. Further, terminal 200 receives the information configured based on the configuration related to the feedback for the HARQ process in the DAI indicating the number of data assignments in the HARQ process, and controls data reception based on the received information.

For example, terminal 200 receives a DAI value of a feedback-enabled HARQ process in a DAI field in DCI assigning data of a feedback-disabled HARQ process, and this increases the identifiability (or specific success rate) of the HARQ-ACK codebook size in the feedback-enabled HARQ process, thereby improving the HARQ retransmission control efficiency.

In addition, for example, terminal 200 receives a transmission parameter for data of a feedback-disabled HARQ process in a DAI field in DCI assigning the data of the feedback-disabled HARQ process. For example, terminal 200 can reduce a reception error rate of the data of the feedback-disabled HARQ process by receiving a transmission parameter that possibly reduces BLER, thereby improving the HARQ retransmission control efficiency.

Thus, according to the present embodiment, it is possible to improve the efficiency of HARQ processing by using DAI (e.g., C-DAI and T-DAI) for a feedback-disabled HARQ process.

Embodiments of the present disclosure have been each described, thus far.

Note that, although transmission of downlink data (e.g., PDSCH) from base station 100 to terminal 200 has been described in the above embodiments, an embodiment of the present disclosure is not limited thereto and may be applied to uplink data (e.g., PUSCH) from terminal 200 to base station 100 or data in a link (e.g., sidelink) between terminals 200. Further, although retransmission of data (e.g., PDSCH) has been described in the above embodiments, a retransmission target is not limited to data (or data channel) and may be another signal or channel.

HARQ-ACK bits included in a HARQ-ACK codebook are not limited to HARQ-ACK bits for PDSCH reception and may be HARQ-ACK bits for other signals. For example, a HARQ-ACK codebook may include HARQ-ACK bits for DCI indicating semi-persistent scheduling (SPS) release (or also referred to as SPS PDSCH release) or Scell dormancy. In addition, a C-DAI value and a T-DAI value including the HARQ-ACK bits may be indicated in both a C-DAI field and a T-DAI field.

In the above-described embodiments, a description has been given of a case where both the C-DAI field and T-DAI field are indicated to terminal 200, but the present disclosure is not limited thereto, and one of the C-DAI field and T-DAI field may be indicated to terminal 200 and the other may not be indicated to terminal 200. For example, when terminal 200 is configured with a single CC (or single cell), information of the C-DAI field may be indicated to terminal 200 and information of the T-DAI field may not be indicated to terminal 200. In this case, for example, the C-DAI field in DCI assigning a feedback-disabled HARQ process may include a C-DAI value in which data assignment in the feedback-disabled HARQ process is not counted, as in Configuration Method 1 or Configuration Method 4 described above.

Further, the above-described Configuration Methods 1 to 4 may be combined according to a base station or cell parameter configuration. For example, Configuration Method 4 may be used when a single CC (or single cell) is configured, and Configuration Method 3 may be used when a plurality of CCs (or a plurality of cells) are configured. In this case, when a single CC (or single cell) is configured, a C-DAI value may be indicated to terminal 200 in a C-DAI field in DCI assigning a feedback-disabled HARQ process, and information of a T-DAI field may not be indicated. Meanwhile, when a plurality of CCs (or a plurality of cells) are configured, the C-DAI field in DCI assigning the feedback-disabled HARQ process may be reserved, or information other than the C-DAI value may be indicated to terminal 200 as in Usages 1 to 4, and a T-DAI value may be indicated to terminal 200 in the T-DAI field.

“Type 3 HARQ-ACK codebook” in which terminal 200 collectively transmits the past HARQ-ACKs is specified considering, for example, a possibility that terminal 200 does not transmit HARQ-ACK during the operation in an unlicensed band (also referred to as NR-Unlicensed (NR-U), for example). For example, an embodiment of the present disclosure may be applied when the Type3 HARQ-ACK codebook is used. An embodiment of the present disclosure may also be applied when another HARQ-ACK codebook is used in addition to the Type3 HARQ-ACK codebook, for example, when information on the HARQ-ACK codebook size is indicated by DAI.

Although, in the above-described embodiments, a description has been given of a case of using a DAI field, which is a field for indicating a parameter on the number of data assignments, a field used for indicating information to terminal 200 is not limited thereto in an embodiment of the present disclosure. For example, the field used for indicating information to terminal 200 in an embodiment of the present disclosure may be another field related to HARQ or HARQ-ACK feedback such as a HARQ process ID, NDI, RV, PDSCH-to-HARQ_feedback timing indicator. Also, for example, the field used for indicating information to terminal 200 in an embodiment of the present disclosure may be specified as a reserved field in a certain release (e.g., Release 17), and may be used for a purpose other than indication of the information on the number of data assignments in the subsequent releases.

NR Rel. 15/16 specifies DCI formats 1_0, 1_1, and 1_2 as a DCI format used for downlink scheduling (data assignment), and an embodiment of the present disclosure may be applied to all of these DCI formats or at least one of them. In addition, indication information in a DAI field may be changed individually for each DCI format.

Further, although a description has been given of an example where HARQ feedback is enabled or disabled individually for the HARQ processes, HARQ feedback may be enabled or disabled individually for the terminals or individually for the cells.

Instead of being reserved as a DAI (C-DAI, T-DAI) field, for example, the DAI field itself may be deleted and the field may be specified as a different reserved field. For example, when information other than DAI as described in Usages 1 to 4 is indicated, a different field name may be specified.

An embodiment of the present disclosure is also applicable to any type of satellite such as a GEO, medium earth orbit satellite (MEO), LEO, or highly elliptical orbit satellite (HEO). Further, an embodiment of the present disclosure may be applied to non-terrestrial communication such as communication performed by a HAPS or a drone base station.

Further, the above embodiments have been described by taking the NTN environment (e.g., satellite communication environment) as an example, but the present disclosure is not limited thereto. The present disclosure may be applied to other communication environments (e.g., at least one terrestrial cellular environment in LTE and NR). For example, an embodiment of the present disclosure may be applied to terrestrial communication in an environment where the cell size is large and the propagation delay between base station 100 and terminal 200 is longer (e.g., equal to or longer than a threshold), for example. In addition, an embodiment of the present disclosure may be applied not only to the NTN but also to communication to which HARQ or feedback-disabled HARQ is applied.

Further, in the above-described embodiment, the satellite communication may have a configuration in which the base station functionality is on the satellite (e.g., “regenerative satellite”), or a configuration in which the base station functionality is on the ground and the satellite relays the communication between the base station and a terminal (e.g., “transparent satellite”). In other words, in an embodiment of the present disclosure, for example, the downlink and uplink may be a link between a terminal and the satellite or a link via the satellite.

The parameters in the above-described embodiments are examples and may include other values. For example, the numbers of slots and CCs to which the number of data assignments is indicated by DAI are not limited to two slots and four CCs, and may include other numbers of slots and CCs. In addition, the HARQ-ACK codebook size is not limited to the examples illustrated in FIG. 7 to FIG. 10, and may include another size. Further, the number of bits of at least one of a C-DAI field and a T-DAI field included in DAI is not limited to 2 bits and may include another number of bits. Furthermore, in FIG. 7 to FIG. 10, at least one of the position (e.g., CC2 of slot2) and the number (e.g., one) of a feedback-disabled HARQ processes may include another value.

HARQ-ACK may be referred to as ACK/NACK or HARQ-feedback, for example.

The base station may be referred to as a gNodeB or a gNB. Further, the terminal may be referred to as UE.

A Slot may be replaced with a time slot, a mini-slot, a frame, a subframe, or the like.

Further, any component with a suffix, such as “-er”, “-or”, or “-ar” in the above-described embodiments may be replaced with other terms such as “circuit (circuitry)”, “device”, “unit,” or “module”.

### (Supplement)

Information indicating whether terminal 200 supports the functions, operations, or processing described in the above embodiment may be transmitted (or indicated) from terminal 200 to base station 100 as, for example, capability information or a capability parameter of terminal 200.

The capability information may include information elements (IEs) individually indicating whether terminal 200 supports at least one of the functions, operations, and processing described in the above embodiment. Alternatively, the capability information may include an information element indicating whether terminal 200 supports a combination of any two or more of the functions, operations, and processing described in the above embodiment.

Base station 100, for example, may determine (decide or assume), based on the capability information received from terminal 200, the functions, operations, and processing supported (or unsupported) by terminal 200 that has transmitted the capability information. Base station 100 may perform operations, processing, or control according to the determination result based on the capability information. For example, base station 100 may control at least one of downlink resource allocation, such as PDCCH or PDSCH, and uplink resource allocation, such as PUCCH or PUSCH (e.g., scheduling including configuration in a DAI field), based on the capability information received from terminal 200.

Note that the fact that terminal 200 does not support some of the functions, operations, or processing described in the above embodiment may be interpreted as limitation of such functions, operations, or processing in terminal 200. For example, information or a request related to such limitation may be indicated to base station 100.

Information on the capability or limitation of terminal 200 may be, for example, defined in a standard, or implicitly indicated to base station 100 in association with information known in base station 100 or information transmitted to base station 100.

### (Control Signal)

In the present disclosure, the downlink control signal (or downlink control information) relating to the exemplary embodiment of the present disclosure may be a signal (or information) transmitted in a Physical Downlink Control Channel (PDCCH) of a physical layer, for example, or may be a signal (or information) transmitted in a Medium Access Control Control Element (MAC CE) or Radio Resource Control (RRC) in a higher layer. Further, the signal (or information) is not limited to that notified by the downlink control signal, but may be predefined in the specifications (or standard) or may be pre-configured for the base station and the terminal.

In the present disclosure, the uplink control signal (or uplink control information) relating to the exemplary embodiment of the present disclosure may be, for example, a signal (or information) transmitted in a PUCCH of the physical layer or a signal (or information) transmitted in the MAC CE or RRC of the higher layer. Further, the signal (or information) is not limited to that notified by the uplink control signal, and may be predefined in the specifications (or standard) or may be pre-configured for the base station and the terminal. The uplink control signal may be replaced with, for example, uplink control information (UCI), 1st stage sidelink control information (SCI), or 2nd stage SC.

### (Base Station)

In one exemplary embodiment of the present disclosure, the base station may be a Transmission Reception Point (TRP), a cluster head, an access point, a Remote Radio Head (RRH), an eNodeB (eNB), a gNodeB (gNB), a Base Station (BS), a Base Transceiver Station (BTS), a master device, a gateway, or the like. Further, in the sidelink communication, a terminal may play a role of the base station. Alternatively, the base station may be replaced with a relay device that relays communication between a higher node and a terminal, or may be replaced with a roadside device.

### (Uplink/Downlink/Sidelink)

One exemplary embodiment of the present disclosure may be applied to, for example, any of an uplink, a downlink, and a sidelink. For example, one exemplary embodiment of the present disclosure may be applied to a Physical Uplink Shared Channel (PUSCH), a Physical Uplink Control Channel (PUCCH), and a Physical Random Access Channel (PRACH) in the uplink, a Physical Downlink Shared Channel (PDSCH), PDCCH or a Physical Broadcast Channel (PBCH) in the downlink, or a Physical Sidelink Shared Channel (PSSCH), a Physical Sidelink Control Channel (PSCCH), a Physical Sidelink Broadcast Channel (PSBCH) in the sidelink.

Note that the PDCCH, PDSCH, PUSCH and PUCCH are one examples of a downlink control channel, a downlink data channel, an uplink data channel, and an uplink control channel, respectively. The PSCCH and PSSCH are one examples of a sidelink control channel and a sidelink data channel. Further, PBCH and PSBCH are broadcast channels, and PRACH is an exemplary random access channel.

### (Data Channel/Control Channel)

One exemplary embodiment of the present disclosure may be applied to, for example, either of a data channel or a control channel. For example, a channel in one exemplary embodiment of the present disclosure may be replaced with any one of the PDSCH, PUSCH, and PSSCH being the data channels or the PDCCH, PUCCH, PBCH, PSCCH, and PSBCH being the control channels.

### (Reference Signal)

In one exemplary embodiment of the present disclosure, a reference signal is a signal known to both of a base station and a mobile station, for example, and may also be referred to as a Reference Signal (RS) or a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### (Time Interval)

In one exemplary embodiment of the present disclosure, the units of time resources are not limited to one or a combination of slots and symbols, but may be time resource units such as, for example, frames, superframes, subframes, slots, time slot subslots, minislots, or symbols, Orthogonal Frequency Division Multiplexing (OFDM) symbols, Single Carrier-Frequency Division Multiplexing (SC-FDMA) symbols, or other time resource units. The number of symbols included in one slot is not limited to the number of symbols exemplified in the above-described embodiments, and may be another number of symbols.

### (Frequency Band)

One exemplary embodiment of the present disclosure may be applied to either a licensed band or an unlicensed band.

### (Communication)

One exemplary embodiment of the present disclosure may be applied to any of communication between a base station and a terminal (Uu link communication), communication between a terminal and a terminal (Sidelink communication), and communication of a Vehicle to Everything (V2X). For example, the channel in one exemplary embodiment of the present disclosure may be replaced with the PSCCH, PSSCH, Physical Sidelink Feedback Channel (PSFCH), PSBCH, PDCCH, PUCCH, PDSCH, PUSCH, or PBCH.

In addition, one exemplary embodiment of the present disclosure may be applied to either of a terrestrial network or a network other than the terrestrial network using a satellite or a High Altitude Pseudo Satellite (HAPS) (Non-Terrestrial Network (NTN)). Further, one exemplary embodiment of the present disclosure may be applied to a terrestrial network having a larger transmission delay in comparison to a symbol length or a slot length, such as a network having a large cell size or an ultra-wideband transmission network.

### (Antenna Port)

In one exemplary embodiment of the present disclosure, an antenna port refers to a logical antenna (antenna group) composed of one physical antennas or a plurality of physical antennas. For example, the antenna port does not necessarily refer to one physical antenna, and may refer to an array antenna including a plurality of antennas. For example, it is not defined how many physical antennas the antenna port is composed of, and the number of physical antennas may be defined as the smallest unit allowing a terminal station to transmit a Reference signal. Also, the antenna port may be defined as the smallest unit multiplied by a weight of a precoding vector.

### <5G NR System Architecture and Protocol Stack>

3GPP has been working at the next release for the 5th generation cellular technology, simply called 5G, including the development of a new radio access technology (NR) operating in frequencies ranging up to 100 GHz. The first version of the 5G standard was completed at the end of 2017, which allowed proceeding to 5G NR standard-compliant trials and commercial deployments of terminals (e.g., smartphones).

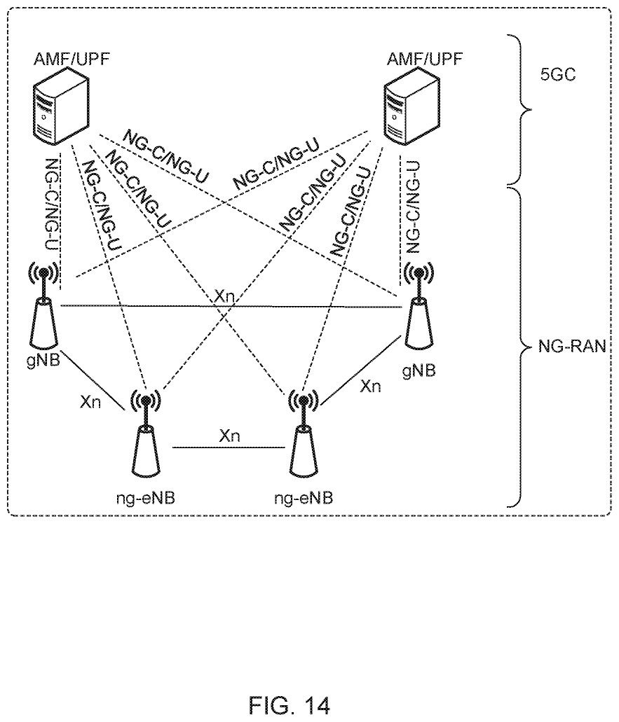

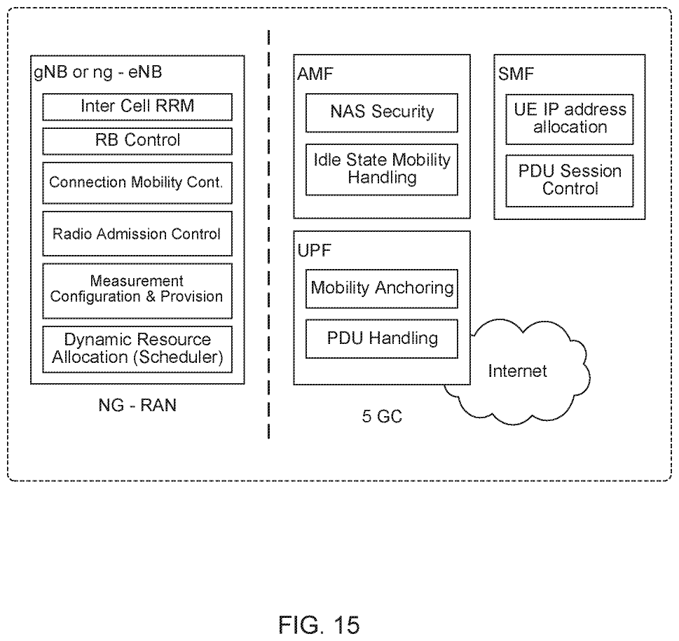

For example, the overall system architecture assumes an NG-RAN (Next Generation-Radio Access Network) that includes gNBs. The gNB provides the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 14 (see e.g., 3GPP TS 38.30 v15.6.0, section 4).

The user plane protocol stack for NR (see e.g., 3GPP TS 38.300, section 4.4.1) includes the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC, and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

### <Functional Split Between NG-RAN and 5GC in 5G NR>

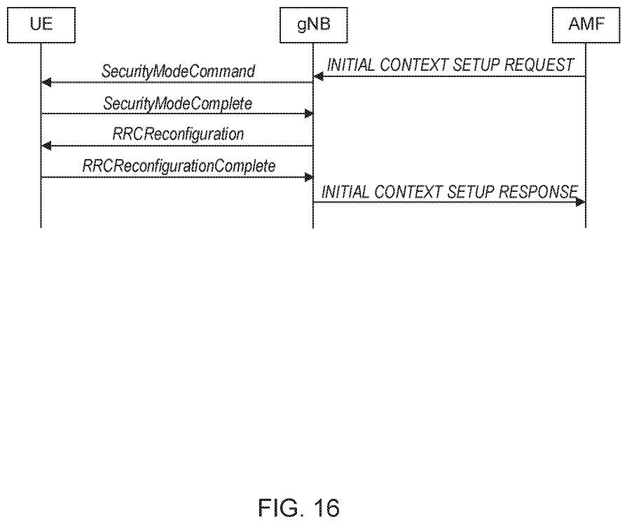

FIG. 15 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an action management maintenance function (OAM: Operation, Admission, Maintenance));
Measurement and measurement reporting configuration for mobility and scheduling;
Transport level packet marking in the uplink;
Session management;
Support of network slicing;
QoS flow management and mapping to data radio bearers;
Support of UEs in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing;
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering, gating, UL/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### <RRC Connection Setup and Reconfiguration Procedure>

FIG. 16 illustrates some interactions between a UE, gNB, and AMF (a 5GC Entity) performed in the context of a transition of the UE from RRC_IDLE to RRC_CONNECTED for the NAS part (see TS 38 300 v15.6.0).

The RRC is higher layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer (s), DRB (s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB informs the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which, in operation, transmits an initial context setup message to the gNodeB via the NG connection such that a signaling radio bearer between the gNodeB and a User Equipment (UE) is configured up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### <Usage Scenarios of IMT for 2020 and Beyond>

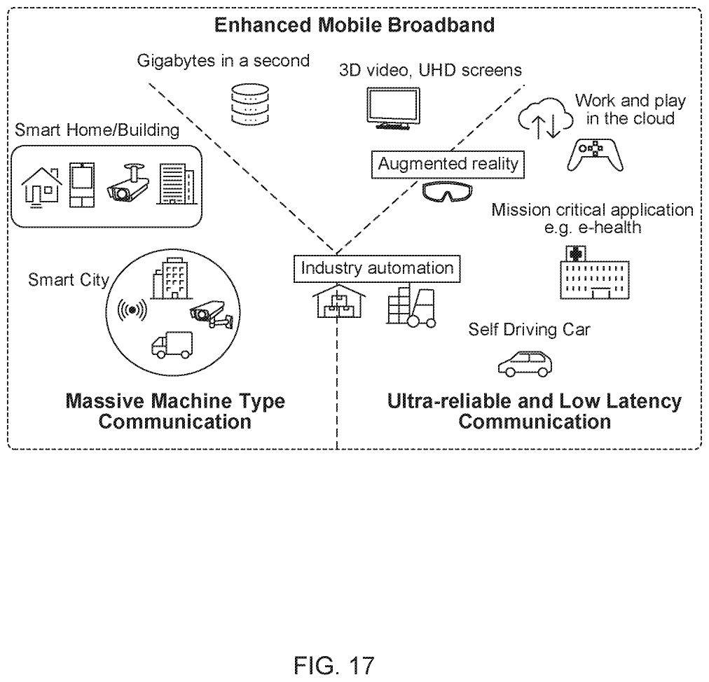

FIG. 17 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 17 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements configured by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been identified such as factory automation, transport industry and electrical power distribution. The tighter requirements are higher reliability (up to 10-6 level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TIT) including a smaller number of symbols than a slot (a slot comprising fourteen symbols).

### <QoS Control>

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearer (DRB) together with the PDU Session, e.g., as illustrated above with reference to FIG. 16. Further, additional DRB (s) for QoS flow (s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

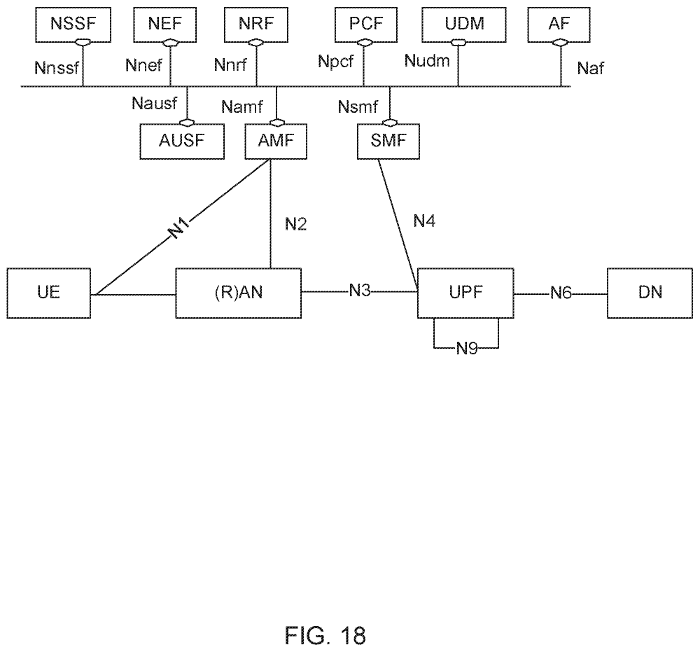

FIG. 18 illustrates a 5G NR non-roaming reference architecture (see TS 23.501 v16.1.0, section 4.23). An Application Function (AF), e.g., an external application server hosting 5G services, exemplarily described in FIG. 17, interacts with the 3GPP Core Network in order to provide services, e.g., to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 18 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g., operator services, Internet access or 3rd party services. All of or a part of the core network functions and the application services may be deployed and running on cloud computing environments.

In the present disclosure, thus, an application server (for example, AF of the 5G architecture), is provided that includes, a transmitter, which, in operation, transmits a request containing a QoS requirement for at least one of URLLC, eMMB and mMTC services to at least one of functions (e.g., NEF, AMF, SMF, PCF, UPF, etc.) of the 5GC to establish a PDU session including a radio bearer between a gNodeB and a UE in accordance with the QoS requirement; and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g. cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A base station according to an embodiment of the present disclosure includes: control circuitry, which, in operation, determines information to be configured to a signal based on a configuration related to feedback for a retransmission process, the signal indicating a number of assignments of data in the retransmission process, and transmission circuitry, which, in operation, transmits the information in the signal.

In an embodiment of the present disclosure, the control circuitry, which, in operation, configures the information on the number of assignments in a first retransmission process for which the feedback is enabled to the signal for a second retransmission process for which the feedback is disabled.

In an embodiment of the present disclosure, the control circuitry, which, in operation, does not count an assignment of the data for the second retransmission process in configuring the information on the number of assignments.

In an embodiment of the present disclosure, the control circuitry, which, in operation, does not configure the information on the number of assignments of the data in at least some field of the signal for a retransmission process for which the feedback is disabled.

In an embodiment of the present disclosure, the control circuitry, which, in operation, configures the information on the number of assignments for a retransmission process for which the feedback is enabled in a field other than the field in which the information is not configured in the signal for a retransmission process for which the feedback is disabled.

In an embodiment of the present disclosure, the field in which the information is not configured is at least one of a first field indicating a cumulative number of assignments of the data for each component carrier and each slot and/or a second field indicating a total number of assignments of the data for each slot.

In an embodiment of the present disclosure, the control circuitry, which, in operation, configures information other than the information on the number of assignments of the data in the field in which the information on the number of assignments of the data is not configured.

In an embodiment of the present disclosure, the control circuitry, which, in operation, configures known information between the base station and a terminal in the field in which the information on the number of assignments of the data is not configured.

In an embodiment of the present disclosure, the control circuitry, which, in operation, configures a parameter related to transmission of the data in the retransmission process for which the feedback is disabled in the field in which the information on the number of assignments of the data is not configured.

In an embodiment of the present disclosure, the parameter is at least one of a number of repetitions of the data, a parameter related to coding and modulation of the data, a parameter indicating whether the data is retransmission data, and/or a parameter related to transmit power of the data.

A terminal according to an embodiment of the present disclosure includes: reception circuitry, which, in operation, receives information configured based on a configuration related to feedback for a retransmission process in a signal indicating a number of assignments of data in the retransmission process; and control circuitry, which, in operation, controls reception of the data based on the information.

A communication method according to an embodiment of the present disclosure includes: determining, by a base station, information to be configured to a signal based on a configuration related to feedback for a retransmission process, the signal indicating a number of assignments of data in the retransmission process; and transmitting, by the base station, the information in the signal.

A communication method according to an embodiment of the present disclosure includes: receiving, by a terminal, information configured based on a configuration related to feedback for a retransmission process in a signal indicating a number of assignments of data in the retransmission process; and controlling, by the terminal, reception of the data based on the information.

The disclosure of Japanese Patent Application No. 2021-064668, filed on Apr. 6. 2021, including the specification, drawings, and abstract, is incorporated herein by reference in its entirety.

### INDUSTRIAL APPLICABILITY

One aspect of the present disclosure is useful for radio communication systems.

### REFERENCE SIGNS LIST

100 Base station
101 Retransmission controller
102, 205 Encoder/modulator
103, 206 Radio transmitter
104, 201 Antenna
105, 202 Radio receiver
106, 203 Demodulator/decoder
107 HARQ-ACK determiner
200 Terminal
204 HARQ-ACK generator

1. A base station, comprising:
control circuitry, which, in operation, determines information to be configured to a signal based on a configuration related to feedback for a retransmission process, the signal indicating a number of assignments of data in the retransmission process, and
transmission circuitry, which, in operation, transmits the information in the signal.

2. The base station according to claim 1, wherein the control circuitry, which, in operation, configures the information on the number of assignments in a first retransmission process for which the feedback is enabled to the signal for a second retransmission process for which the feedback is disabled.

3. The base station according to claim 2, wherein the control circuitry, which, in operation, does not count an assignment of the data for the second retransmission process in configuring the information on the number of assignments.

4. The base station according to claim 1, wherein the control circuitry, which, in operation, does not configure the information on the number of assignments of the data in at least some field of the signal for a retransmission process for which the feedback is disabled.

5. The base station according to claim 4, wherein the control circuitry, which, in operation, configures the information on the number of assignments for a retransmission process for which the feedback is enabled in a field other than the field in which the information is not configured in the signal for a retransmission process for which the feedback is disabled.

6. The base station according to claim 4, wherein the field in which the information is not configured is at least one of a first field indicating a cumulative number of assignments of the data for each component carrier and each slot and/or a second field indicating a total number of assignments of the data for each slot.

7. The base station according to claim 4, wherein the control circuitry, which, in operation, configures information other than the information on the number of assignments of the data in the field in which the information on the number of assignments of the data is not configured.

8. The base station according to claim 7, wherein the control circuitry, which, in operation, configures known information between the base station and a terminal in the field in which the information on the number of assignments of the data is not configured.

9. The base station according to claim 7, wherein the control circuitry, which, in operation, configures a parameter related to transmission of the data in the retransmission process for which the feedback is disabled in the field in which the information on the number of assignments of the data is not configured.

10. The base station according to claim 9, wherein the parameter is at least one of a number of repetitions of the data, a parameter related to coding and modulation of the data, a parameter indicating whether the data is retransmission data, and/or a parameter related to transmit power of the data.

11. A terminal, comprising:
reception circuitry, which, in operation, receives information configured based on a configuration related to feedback for a retransmission process in a signal indicating a number of assignments of data in the retransmission process; and
control circuitry, which, in operation, controls reception of the data based on the information.

12. A communication method, comprising:
determining, by a base station, information to be configured to a signal based on a configuration related to feedback for a retransmission process, the signal indicating a number of assignments of data in the retransmission process; and
transmitting, by the base station, the information in the signal.

13. A communication method, comprising:
receiving, by a terminal, information configured based on a configuration related to feedback for a retransmission process in a signal indicating a number of assignments of data in the retransmission process; and
controlling, by the terminal, reception of the data based on the information.
